(19) United States
(12) Patent Application Publication
(10) Pub. No.: US 2014/0379813 A1
(43) Pub. Date: Dec. 25, 2014

(54) METHOD AND SYSTEM FOR PROVIDING INTELLIGENT MESSAGING

(71) Applicant: Verizon Patent and Licensing Inc., Basking Ridge, NJ (US)

(72) Inventors: Rahim CHARANIA, Euless, TX (US); Ramesh MARIMUTHA, Edison, NJ (US); Kevin LIM, Danville, CA (US); Alex HOYOS, Miami, FL (US)

(21) Appl. No.: 13/923,994

(22) Filed: Jun. 21, 2013

(51) Int. Cl. H04L 12/58

(52) U.S. Cl. CPC H04L 51/02; H04L 51/24
USPC 709/206

(57) ABSTRACT

An approach is provided for intelligent messaging. The approach includes determining a contact, content information, or combination thereof associated with a message. The approach also includes identifying one or more messaging features associated with the contact and/or the content information. The approach further includes configuring a messaging application to provide the one or more messaging features when processing the message via the messaging application.

### BACKGROUND INFORMATION

Messaging (e.g., text messages, multimedia messages, chats, etc.) has become a popular form of communication. This popularity has often led to an increasing burden on users (e.g., in time and effort) to process, respond to, or otherwise manage an ever-growing incoming flow of messages. This burden is further increased when users address messaging occurring in different contexts (e.g., home, work, family, friends, etc.), that often are handled using different responses and/or message processing features. As a result, service providers and device manufacturers face significant technical challenges to enable a messaging application or system that can intelligently and flexibly manage incoming messaging streams.

Based on the foregoing, there is a need for adapting the messaging features of a messaging application based on the contact(s) and/or content information associated with the messages processed by the messaging application.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1A is a diagram of a system capable of adapting messaging features based on contact and/or content information, according to one embodiment;

FIG. 1B is a diagram of a system utilizing a messaging application platform over a cloud network, according to one embodiment;

FIG. 2 is a diagram of a messaging application platform capable of adapting messaging features based on contact and/or content information, according to one embodiment;

FIG. 3 is a flowchart of adapting messaging features based on contact and/or content information, according to one embodiment;

FIG. 4 is a flowchart of executing various messaging features associated with contact and/or content information, according to one embodiment;

FIG. 5 is a flowchart for providing generated results based on information collected in the messaging application database, according to one embodiment;

FIG. 6 is a diagram of a messaging application platform used in the processes of FIGS. 3-5, according to one embodiment;

FIGS. 7A and 7B are diagrams of call flows for out of office and future messages, respectively, used in the process of FIG. 4, according to one embodiment;

FIGS. 8A and 8B are diagrams of user interfaces utilized in the process of FIG. 4, according to one embodiment;

FIG. 9 is a diagram of a user interface utilized in the process of FIG. 4, according to one embodiment;

FIG. 10 is a diagram of a user interface utilized in the process of FIG. 4, according to one embodiment;

FIG. 11 is a diagram of a user interface utilized in the process of FIG. 5, according to one embodiment;

FIG. 12 is a diagram of a user interface utilized in the process of FIG. 4, according to one embodiment;

FIG. 13 is a diagram of a computer system that can be used to implement various exemplary embodiments; and

FIG. 14 is a diagram of a chip set that can be used to implement various exemplary embodiments.

### DESCRIPTION OF THE PREFERRED EMBODIMENT

An apparatus, method, and software for providing intelligent messaging, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

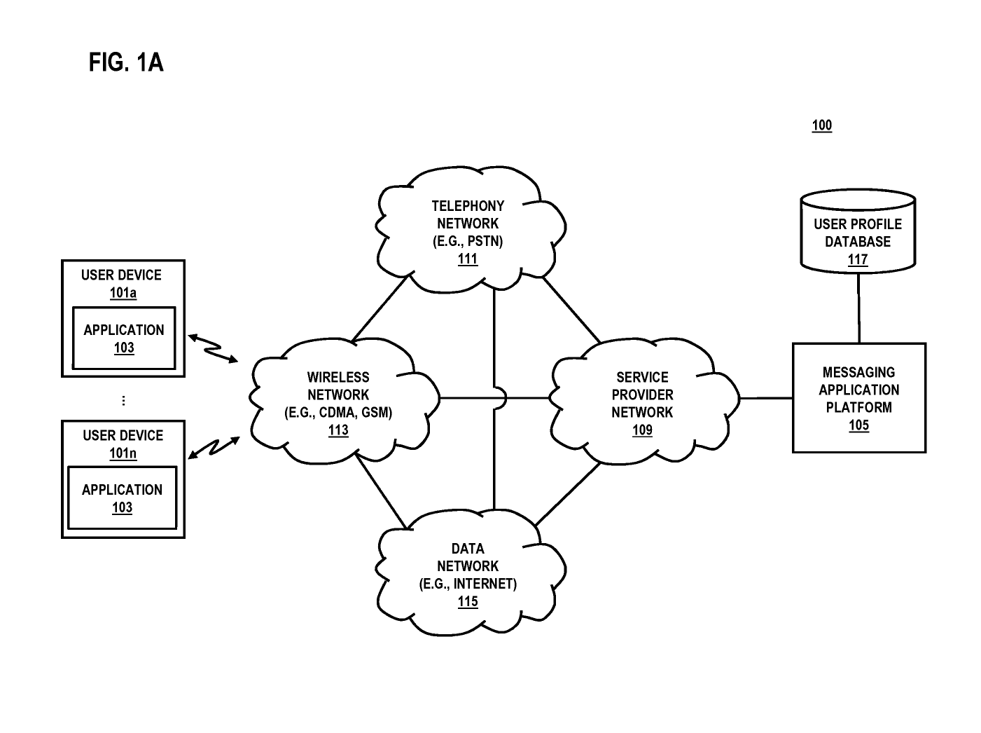

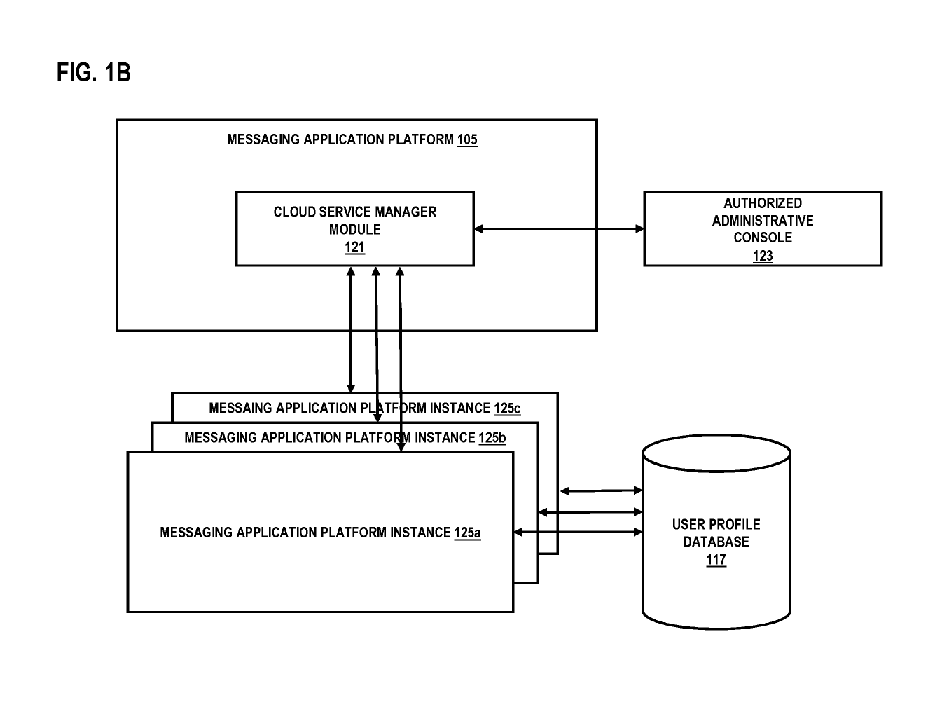

FIG. 1A is a diagram of a system capable of adapting messaging features based on contact and/or content information, according to one embodiment. As noted above, one challenge for a messaging application or system is to enable users to more efficiently process messages based on the context of the messages. By way of example, the context of the messages can often be indicated by the contact(s) sending/receiving the message or the content information (e.g., keywords, text, pictures, etc.) within the messages themselves. Other ways of indicating context can include, for instance, location, time, activity of the user, etc. Traditional messaging applications generally have messaging features and/or customization options that are applied to all contexts (e.g., all of a user's contacts) equally. This general applicability approach can potentially limit a user's ability to select and/or personalize the feature on a context-by-context (e.g., a contact-by-contact) basis.

For example, with respect to a messaging feature such as a customized dictionary feature, traditional messaging applications may learn commonly used words without regard to the sending or receiving contact of a message, which may limit the application's ability to learn commonly used words that are most relevant for particular contexts (e.g., for a particular contact). In other words, it can often be the case that the most common words or phrases to use in a particular dictionary depends on which contact or context is associated with the message. For example, a user may text “I love you” on a daily basis to the user's spouse, but the messaging application's ability to learn this common phrase may not be applicable when the user texts an employer, babysitter, or casual acquaintances. In another example, with respect to a messaging feature such as an automated response feature, the user may want to apply the feature with a customized set of responses specific to the contact associated with the message. However, traditional messaging applications historically have automated responses that are general to all contacts and/or contexts.

To address this problem, a system 100 of FIG. 1 introduces the capability to specify which messaging feature to make available on a context-by-context basis, and also to customize the feature on a context-by-context basis. In the various embodiments described herein, context is indicated based on a contact (e.g., a sending contact when receiving a message, a recipient contact when sending a message) or content information (e.g., keywords, topics, pictures, audio, etc.) associated with a message. However, it is contemplated that various embodiments described herein are applicable to any context associated with a message (e.g., location, time, activity of sender/receiver, communication history, social relationship, etc.).

In addition, as used herein, messaging features include any function or operation that can be applied to a message. By way of example, messaging features include: (1) auto filling and prompting; (2) automated responses to received messages; (3) automated processing of received messages; (4) popup displays for received messages; (5) personalized notifications, e.g., ringtones; (6) defining message treatments for all or selected messages; (7) message tracking and reporting; (8) customizing messages with media or themes; (9) blind carbon copying for sent messages; (10) sending messages in the future; (11) repeat message sending; (12) repeat message sending until a response is received; (13) message escalation if response is note received; (14) storage of messages on external devices, memory cards, network servers, cloud servers, etc.; (15) message folders; (16) message search capabilities; (17) message account merging; (18) user acknowledgements; etc. The above messaging features are provided as examples and are not intended to limit the application of the various embodiments. These messaging features are described in further detail below.

In one embodiment, the system 100 provides the capability of determining messaging features based on contacts and/or content information by providing a user with the option of associating various messaging features to contacts and/or content information. The system 100 then enables the user to customize the messaging feature for that particular contact and/or content information (e.g., as parsed from message contents). In one embodiment, a user may select message features or treatments for sent and received messages (e.g., short message service (SMS) text messages and multimedia messaging service (MMS) messages). For example, automatic responses and message processing may be independently selected so incoming or outgoing messages may receive more than one message feature activated for automatic treatment. In one embodiment, user settings may specify which automatic messaging feature or application behaviors may be performed for various contacts or groups, rather than universally applied settings for all messages. By way of example, selective message pop up displays, ringtones, reporting, scheduling messages for future delivery, repeat sending, and message searching are some of the other features which may be selectable and configurable by contact based on user needs. According to one embodiment, some of the user and contact specific features or behaviors of a messaging application, such as auto fill and prompting, are adjusted automatically, so users do not have to frequently change settings. Therefore, system 100 may determine a contact, content information, or combination thereof associated with a message, identify one or more messaging features associated with the contact, the content information, or combination thereof, and configure a messaging application to provide the one or more messaging features when processing the message via the messaging application.

In one embodiment, with the auto fill or prompting feature, the system 100 may have an intelligent feature that remembers the words commonly used by the user of the application when typing messages to a given contact. This feature fills in or prompts the user with commonly used words when the user is composing a message. The auto fill or prompting dictionary may be unique for each contact. In other words, a dictionary of commonly used words by the user can be created and maintained for individual contacts instead of having one dictionary for all contacts. The prompting feature works exactly the same way as auto fill, except it only prompts the user with the word, instead of automatically filling in the word. According to one embodiment, the user has to press the “Enter” key to have the words filled into the message. Therefore, system 100 may have one or more messaging application features including an auto-fill feature, a prompting feature, or a combination thereof, the method further comprising: associating an auto-fill dictionary, a prompting dictionary, or a combination with the contact, the content information, or a combination thereof, wherein the auto-fill dictionary, the prompting dictionary, or a combination thereof is unique to the contact, the content information, or a combination thereof.

According to one embodiment, each contact may have any of the available messaging features (e.g., the above listed features) associated with the contact. For example, when a user associates a messaging feature, such as auto fill, with Contact A, the system 100 may learn the words the user most often includes in the user's messages to Contact A. Whenever the user creates a new message for Contact A, the system 100 may automatically generate those commonly used words in the message body. Whenever the user creates a new message for Contact B, C, or D, no such words may be automatically generated (unless the system 100 had separately learned that word for one or more of the other contacts as well). According to one embodiment, users may be able to select whether to use auto fill, prompting, or neither when a new contact is added. According to one embodiment, prompting may be on by default.

In one embodiment, the system 100 may enable a messaging feature to automatically respond to received text messages, as appropriate. The automated response feature, for instance, is selected and customized individually for a contact rather than all contacts or the entire messaging application. For example, users may enable the automated response feature for a contact and set “Out of Office”, “Availability Status”, “Outgoing Greeting”, etc. responses for received text messages from the contact. In one embodiment, predefined messages may be selected or custom text may be written, and such custom messages may be sent as responses based on user criteria to define the applicable contact. In one embodiment, the primary criterion for determining the correct automatic response to be sent as a reply is the sender's contact number, but other criteria may also be used so that the system 100 may specifically identify the contact to which the feature and associated customizations apply. Thus, system 100 may have one or more messaging application features, wherein the one or more messaging features include an automatic response feature, the method further comprising: associating (a) one or more responses; (b) one or more processing actions (e.g., storing, forwarding, copying, deleting, repeat sending, message escalation, organizing, etc.); (c) one or more criteria for triggering the one or more responses, the one or more processing actions, or a combination thereof; or (d) a combination thereof with the contact, the content information, or a combination thereof, wherein (a) the one or more responses; (b) the one or more processing actions; (c) the one or more criteria for triggering the one or more responses, the one or more actions, or a combination thereof; or (d) a combination thereof are unique to the contact, the content information, or a combination thereof.

According to one embodiment, the system 100 may enable a feature to perform one or more processing actions on sent or received text messages on a context-by-context basis. For instance, the one or more processing actions include forwarding, deleting, filing in folder, etc. For example, users may send messages to an email address, an alternate phone, or co-workers who are working on the same project depending on the contact. According to one embodiment, automatically forwarded messages are marked with “FW:” in the subject line or other forwarding indicator to notify new recipients that they are not the original recipient of the message. According to one embodiment, message processing may be performed for all messages or based on user criteria to identify the applicable context, such as contact or content information. Therefore, system 100 may contain one or more messaging application features, wherein the one or more processing actions include an attachment action, a carbon copying action, a future sending action, a repeat sending action, a message escalation action, a storage action, a message folder creation action, or a combination thereof.

In one embodiment, the system 100 may configure a message feature that enables users to elect to have all or select messages pop up on their mobile device on top of any running application on a context-by-context basis. For example, in some cases, using this feature for all messages may be too disruptive to normal device activities. However, enabling a user to create selection criteria for identifying an applicable context for this feature may be beneficial so that important messages may not be overlooked (e.g., if a message is received from a particular contact). As an example, messages from the user's employer may be selected to pop up on the device screen over other activity on the phone, including a voice call in progress, without ending the voice call. Messages for some senders may immediately pop up on the display, whereas other messages may generate an audio tone initially, and then pop up on the device after a defined period of time if not read. In one embodiment, this feature is selected and configured on a context-by-context basis. Therefore, the system 100 may contain one or more messaging application features, wherein the one or more messaging features include a personalized notification feature, the method further comprising: associating one or more notification types with the contact, the content information, or a combination thereof, wherein the one or more notification types are unique to the contact, the content information, or a combination thereof.

According to one embodiment, the system 100 may enable a message feature to enable users to set unique sound and/or alert settings for individual contacts or groups. In one embodiment, the system 100 enables selection and configuration of the feature on a context-by-context basis. As an example, if a user selects and configures the unique or personalized notification feature for a spouse, the system 100 will configure the messaging application 103 so that the application 103 can detect messages from the user's spouse, and initiate a personalized or unique notification alert (e.g., a ringtone) that is different from notifications used for other contacts. According to one embodiment, the user may select a message ringtone alert that may repeat in a progressively louder manner until acknowledged. Additionally, the user may select ringtones from a list and customize notification parameters or criteria such as: application, time intervals between repetitions, and total duration of the alert. Custom triggers may be created, for instance, to invoke specific messaging behaviors.

According to one embodiment, the handling of messages may be defined for: all received messages, urgent messages, messages received from certain senders, or messages containing certain content. Criteria may also be selected so that message treatments only apply for a specified duration or during certain times of the day on particular days of the week. According to one embodiment, user selection criteria for message responses and processing may be similar to creating filtering rules. For example, a user may set up a special outgoing greeting for messages received from a list of friends, or an employee may choose to copy all messages from a boss containing the word “project” to select co-workers. According to one embodiment, these setting may be stored on the phone (e.g., UD 101) or be saved on servers (e.g., MAP 105). Therefore, system 100 may contain one or more messaging application features, wherein the one or more notification types include a popup notification, an audio notification, a visual notification, or a combination thereof.

In one embodiment, the system 100 may enable a messaging feature to create either manual or automatic reports based on sent or received messages (e.g., messages having certain contexts) for tracking purposes. That is, users may create either a one-time report manually, or the user may set parameters to create automatic reports at pre-set intervals. Additionally, various customized tracking criteria may be defined for the reports. For example, when urgent messages are received, a pre-defined report may be updated and sent to a defined list of recipients on a periodic basis (such as monthly) or just once. For example, the reports may contain: the mobile number of the device that received the urgent messages, number of urgent messages received during the periodic interval, and dates of the sent messages. Other report criteria may include: messages that did not receive responses, messages related to a particular topic, or messages with specific contacts. In one embodiment, the reporting feature may be used to help manage field force workers. Additionally, reports may be generated and transmitted to other mobile devices, email addresses, or stored. In one embodiment, the system 100 may have email servers for inbound and outbound email to support message tracking and reporting features. Thus, the system 100 may generate a message traffic report for the contact, the content information, or a combination thereof.

According to one embodiment, the system 100 may provide message search capabilities based on several data attributes that may be queried. According to one embodiment, such data attributes include: sender, receiver, date, time (or period of time), words or characters used in the subject line and/or message body, animated signs, etc. For example, a user may choose to search for messages sent from a “name” in a given “period of time” containing “words”. According to one embodiment, the user may also set a predefined number of message results to display at a time, such as 10, 20, 50, or 100. In an example, a user may ask for the number of messages received from “name” containing a “word” in a given “period of time”. The user may also assign commands to the search results. For example, the user may ask the system 100 to delete all messages received from “name” containing a “word” in a given “period of time”. In yet another example, the user may query the system 100 to display all messages sent from a “name” in a given “period of time” containing data in the blind carbon copy (BCC) field. Therefore, system 100 may contain one or more messaging application features, wherein the one or more message features include a search feature, the method further comprising determining a message search query based on one or more data attributes associated with the contact, the content information, the message, or a combination thereof.

In one embodiment, the system 100 may support different configurations of the application 103 depending on whether the embodiments of the features described herein are implemented as device-based features or network-based features. For example, if a service provider supports the application 103 in device-based embodiment, the application 103 may be native to the device. If the application 103 is supported by a third party or the user has an older phone, the application 103 may be a downloadable. In one embodiment, the application 103 may have a website portal that provides an alternative method to view and compose messages as well as change user settings. Additionally, there may be an optional downloadable computer client if users want to store and manage messages on the computer. According to one embodiment, the application 103, companion website, and downloadable computer client each require logging in with a mobile number to gain access to the messaging services. For example, if the user has a wireless device number associated with the user's tablet, the user can login with that device's number or the primary mobile device's number depending on which number is used for messaging purposes. Once a user has logged in using a particular device, the user may default to that login if the user chooses to do so. In one embodiment, the application 103 for tablet devices and presentation of features may be optimized to fit the size of the display on the device.

In one embodiment, subscribers (businesses offering the services of system 100 as at least part of their service offerings) may implement system 100 on a mobile device client, network host, cloud-based host, web-based client, or combination thereof. The implementation chosen may determine the varying levels of the system 100's privacy and functionality. According to one embodiment, in a user device-based implementation, where the system 100 may be supported by a wireless carrier, the subscriber may install system 100 native to the device. According to another embodiment, where the user device-based implementation is wireless carrier agnostic, system 100 may be downloaded as a separate application. The messaging solution may be internet protocol (IP) based, or may use traditional Signal System No. 7 (SS7) architecture if the wireless carriers' application programming interfaces (APIs) are used. In short message service center (SMSC), multimedia message service center (MMSC), and other networks supported by a wireless carrier, all user settings would be stored to SMSC and MMSC network servers, which may help back up the user's settings in cases when the user device is not on, or is not working.

In one embodiment, when the application is hosted in a cloud in a wireless carrier agnostic implementation, the cloud based solution may back up application 103 settings to the MAP 105, thus allowing for application 103 settings to be restored from the hosted application 103 to the same or new/replacement device. That is, the when the application is hosted in a cloud in a wireless carrier agnostic implementation, the cloud based solution may act as a failsafe mechanism to recover messages, in the event the user loses their device, or continue to send out of office and intelligent automatic responses, if the device is out of range or turned off. Additionally, messages stored in folders on the device may be backed up to and restored from the MAP 105 with a number of user-configurable settings. For example, users may choose to save backups of application 103: manually, upon message reception, automatically, daily, weekly or monthly.

According to one embodiment, users may also provide a configurable retention period of days, weeks, or months. According to one embodiment, a user may select the retention period limit based on the number of messages: per thread, per user, or globally for all messages. The system 100 may backup generated reports, whether the reports were generated: ad-hoc, on demand, or standing. All application 103 settings may be configured from MAP 105. When settings are changed in MAP 105, they are automatically pushed to the UD 101 as the master copy. According to one embodiment, the user may select device-based management to manage all settings from the UD 101. This setting may require the UD 101 to be powered on and connected to the networks 109-115 in order for functionality to execute. According to one embodiment, the user may select the hosted application, which may allow all functionality to continue to execute, including when the UD 101 is: powered off, out of range, or not connected to the networks 109-115. The system 100 may be IP based, or may use traditional SS7 architecture if wireless carriers' APIs are used. Therefore, system 100 may contain one or more messaging application features, wherein the messaging application is resident on a mobile device client, a network host, a cloud-based host, a web-based client, or a combination thereof.

According to an embodiment where the system 100 is implemented in an SMSC and MMSC network or cloud, an example operation flow in the invention begins with a user starting the application 103 for the first time on the user device 101a-101n (collectively referred to as UD 101). The application 103 may access the contacts list or address book local to the UD 101, as well as user and UD 101 information. The application 103 may save this registration information locally in the UD 101. The application 103 may communicate via wireless network 113. The wireless network 113 may be connected to a telephony network 111, a wireless network 113, a data network 115, or a combination thereof. The application 103 may communicate the registration information via the networks 109-115 to the messaging application platform 105 (MAP). Registration information may comprise of user information from the UD 101, details about the UD 101 such as make, model, etc., and the user's list of contacts from the UD 101's phonebook or contacts list. The MAP 105 may store this data in the user profile database 117. The MAP 105 or application 103 may render a user interface of the user's contact list with a list of features to associate and customize for each contact. As the user associates various features for a contact using the user interface on the application 103 on UD 101, these settings may be saved locally on UD 101 and communicated to the MAP 105 via the networks 109-115. MAP 105 may store the user-created associations with the contact information in the user profile database 117. MAP 105 may then send a confirmation of these updates to the application 103 via networks 109-115. Thereinafter, whenever the user opens application 103, MAP 105 or application 103 may enable the features and settings provided by the user as saved in the user profile database 117 or the UD 101 local's memory. As a result, the user may utilize the application 103 with the features for the contacts according to the user's preferences. Thus, all of application 103's local settings may be synced with the MAP 105. In an embodiment where the system 100 is implemented in a UD 101, sensitive information such as availability status or out of office notifications may not reside on external servers.

In other words, the system 100 supports a device-based embodiment (e.g., implementation at the UD 101) and a network-based embodiment (e.g., implementation at the SMSC/MMSC) when messaging functions are supported by a service provider (e.g., a wireless carrier). For a device-based embodiment, the application 103 provides the functions described herein and is installed native to the UD 101 or is downloaded as a separate application. Under this scenario, user settings, custom messages, media attachments, etc. all reside the user's device (e.g., UD 101). This device-based embodiment keeps all user information within the UD 101. In one embodiment, the information can be encrypted, e.g., in case the UD 101 is lost or stolen. In addition, sensitive or private information such as availability status or out of office notifications would not reside on external servers (e.g., MAP 105). Storing the user information in the UD 101, for instance, increases privacy of the application 103. However, in the event the user loses the UD 101, the user would not be able to download the previous configuration from a central server.

In one embodiment, the system 100 supports an SMSC and MMSC network-based embodiment for wireless-carrier supported messaging applications. By way of example, this network-based embodiment provides all user settings to SMSC and MMSC network servers. This can help the user in cases when the UD 101 is not on or is not operational. All features would continue working in either of these situations. Moreover, the SMSC and MMSC applications would use stored subscriber settings without having to send messages to the UD 101 for any selected special handling. In the even the user loses the UD 101, the user would be able to download the previous configuration from the central servers to a new UD 101 (e.g., a new mobile phone). In one embodiment, maintaining a copy of the user settings on the phone even when the network-based embodiment is selected can facilitate quicker mobile access to the settings for review and/or editing.

For illustrative purposes, the networks 109-115 may be any suitable wireline and/or wireless network, and be managed by one or more service providers. For example, telephony network 111 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 115 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of an SS7 network, or other suitable infrastructure to support control and signaling functions.

According to exemplary embodiments, UD 101 may communicate over system 100 and include any customer premise equipment (CPE) capable of sending and/or receiving information over one or more of networks 109-115. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

The system 100 may also support users who have multiple mobile devices with separate accounts. According to one embodiment, merging messaging accounts may be available so a user may be logged in with any of the user's accounts and obtain all of the messages in those accounts. Messages received may retain the original destination number from the received message. This may make replies to sending parties less confusing. Additionally, the user may have the option to specify a preferred source or sender address for sent messages. Users may also have the option to sort messages based on the destination address for received messages and the sender address for sent messages.

According to another embodiment, subscribers may receive incoming text or MMS messages from a UD 101 or non-traditional device which has SMS/MMS capability built-in to it. Additionally, it may apply to a device which interfaces with a monitoring system equipped with the necessary operating system and application to send out SMS/MMS messages. A UD 101 equipped with a camera, may take a snapshot, along with the incident report. Therefore, an alert may be sent along with video or media content to a specific user. In addition to the device phone number, the incoming message from the UD 101 may contain a value or code indicating the severity and cause. This information may initiate an automated response based on user defined criteria. The response may display the message as a pop up as or additional functions may occur as defined by rules set by the user. The notification may request back an acknowledgement such as a “Read” or “Delivery” Receipt. A configurable number of retries may be generated based on defined rules. In the event a receipt or acknowledgement is never received, an escalation or broadcast may generate an outgoing message to other recipients. The rules for additional messaging activity may be defined for the UD 101 account or based on the message recipient's account. For example, for routine escalations, the user of the UD 101 may choose who is notified when a response is not received. However, for a temporary absence such as a vacation, the intended message recipient may set up a delegate to receive messages in her absence.

FIG. 1B is a diagram of a system utilizing a messaging application platform over a cloud network, according to one embodiment. In one embodiment, the MAP 105 is a multi-tenant platform that can serve multiple service providers, wireless carriers, or other operators (e.g., Mobile Virtual Network Operators (MVNOs), enterprises, etc.). For example, each provider, carrier, or operator may implement unique features, customized look and feel, etc. for respective messaging applications. For example, this multi-tenanted platform 103 can be divided any number of times based on demand. In one embodiment, approximately 80% of the architecture of the MAP 105 remains standard among tenants with the remaining approximately 20% available for customization by providers, carriers, operators, etc. Subscribers to the respective instances of the MAP 105 can be differentiated by, for instance, mobile number so that the subscribers will receive the features that are assigned to them.

In one embodiment, the multi-tenant properties of the MAP 105 are supported by a scalable cloud-based architecture as depicted in FIG. 1B. For example, the MAP 105 is controlled by a cloud service manager module 121. In this example, the authorized administrative console 123 is used to access the cloud service manager module 121 and create instances 125a-125c (also collectively referred to as instances 125) of the MAP 105 for a channel partner (e.g., a provider, carrier, operator, etc.).

The cloud service manager module 121 generates an instance 125 of the MAP 105 on demand associated with a channel partner. Each instance 205 of the MAP 105 gives the channel partner requesting access through the cloud network the ability to manage and customize the services provided. As discussed previously, these services include providing context-specific messaging features.

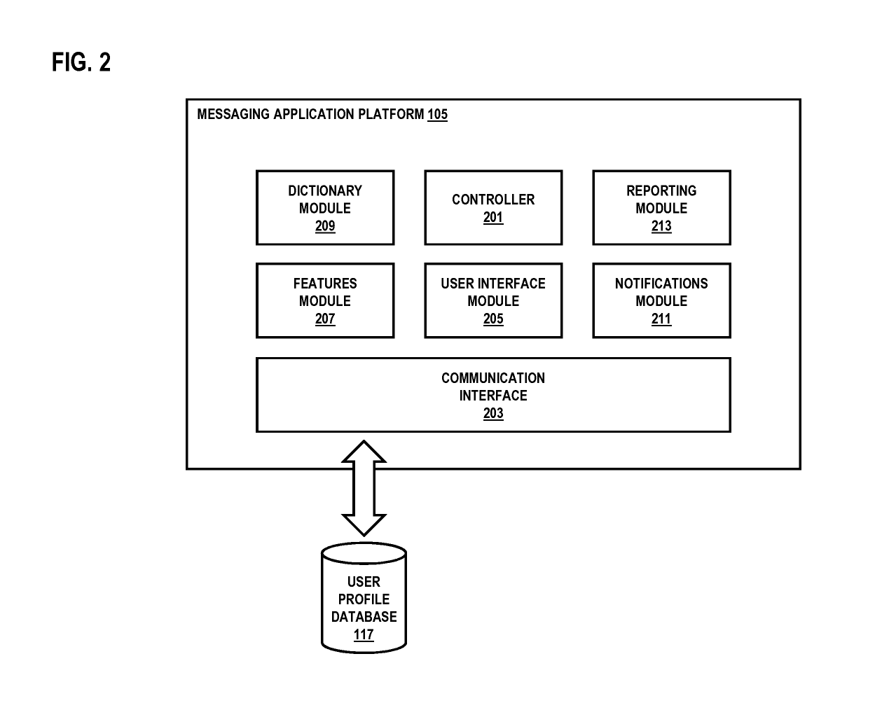

FIG. 2 is a diagram of a messaging application platform capable of adapting messaging features based on contact and/or content information, according to one embodiment. By way of example, MAP 105 includes one or more components for providing customizable messaging features. It is contemplated that the functions of these components may be combined in one or more components or performed by other components of equivalent functionality. In this embodiment, the MAP 105 includes controller 201, communication interface 203, user interface module 205, features module 207, dictionary module 209, notifications module 211, and reporting module 213, all of which may communication with user profile database 117.

The controller 201 performs control logic functions and facilitates coordination among the other components of MAP 105. According to one embodiment, when a user starts the application 103 for the first time, the communication interface may retrieve the registration information from the application 103 via the networks 109-115, and transfer the registration information to the user profile database 117, which may create a new user profile. The user interface module 205 may create a rendering of the contact list from the registration information in the user profile database 117 with features to associate. The updated contacts list with possible features may be communicated to the UD 101 via the networks 109-115 by the communication interface 203 and the controller 201. After the user has selected the desired features for a contact, the communication interface 203 may receive these preferences via the networks 109-115, and the controller 201 may save this data in the user profile database 117. The user interface module 205 may also alter the user interface for the updated contact to reflect a sub-menu of settings for the selected features.

In one embodiment, the communication interface 203 receives notice from application 103 via networks 109-115 that a user has begun to compose a message. After the communication interface 203 receives the new message information from application 103, it may transfer the information to the controller 201, which may access the user profile database 117 to determine which features the user has associated with the message's contact. The controller 201 may then communicate via the communication interface 203 to the features module 207 the features to initiate for the new message. If one of the associated features includes auto fill or prompting, the dictionary module 209 may learn commonly used words and phrases associated with each contact that is associated with the auto fill or prompting feature. If the auto fill feature has been associated with the selected contact of a new message, the features module 207 may automatically insert the commonly used words or phrases associated with the contact. If the prompting feature has been associated with the selected contact of a new message, the features module 207 may prompt the user to select the commonly used words or phrases learned by the dictionary module 209.

According to one embodiment, if the user enters the parameters for a report in application 103, these parameters may be transmitted to the communication interface 203 via the networks 109-115. The communication interface 203 may communicate the report parameters to the reporting module 213 to generate the report. Upon receiving the parameters for the report, the reporting module 213 may access the user profile database to access the data and metadata regarding the message statistics for a particular user. The reporting module 213 may generate a report based on the data in the user profile database. The communication interface 203 may send the generated report to the application 103 via networks 109-115.

In one embodiment, the service provider network 109 is notified that a new message is sent to UD 101. The communication interface 203 may receive details of the message (contact, content information, date, time, etc.) and communicate these details to the features module 207. The features module 207 may determine which contacts the message is from and whether certain notification features have been associated to those contacts and/or content information. In the case where the user has associated notifications for the sending contact, the features module 207 may communicate to the notifications module 211 via communication interface 203 to render the associated notifications. For example, in the case where the user has associated a pop-up message for messages from this contact, the notifications module 211 and user interface module 205 may render a pop-up notification to be displayed by application 103 on UD 101 via networks 109-115 according to the feature settings identified by the features module 207.

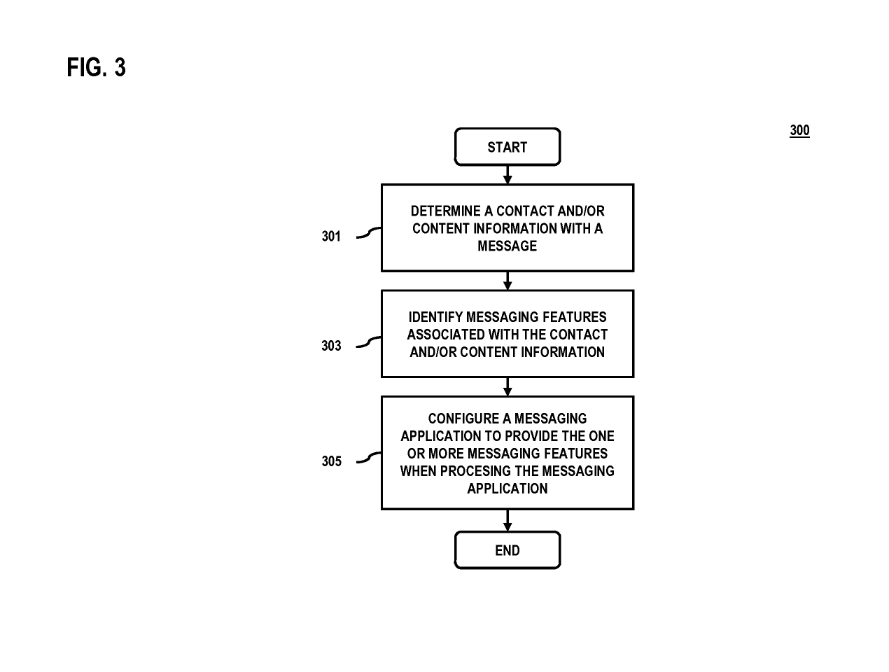

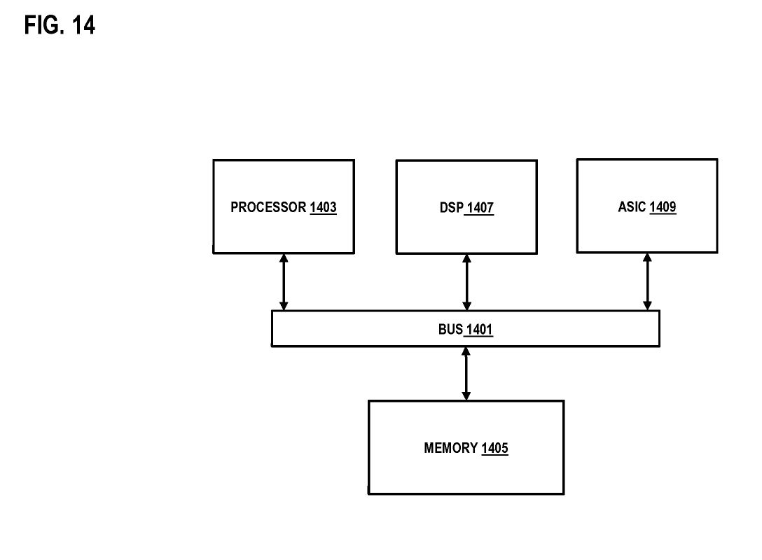

FIG. 3 is a flowchart for adapting messaging features based on contact and/or content information, according to one embodiment. In one embodiment, the MAP 105 performs the process 300 and is implemented in, for instance, a chip set including a processor and a memory as shown in FIG. 14. Although FIG. 3 illustrates steps 301 through 305 in a particular order, the order and number of steps are merely for explanation, and one or more steps may be performed in a different order or removed. In step 301, the MAP 105 may determine a contact, content information, or combination thereof associated with a message. In one embodiment, the MAP 105 may identify the contact the user intends to send the message to, regardless of whether the contact is the direct recipient, a carbon copy (CC) recipient, or a blind carbon copy (BCC) recipient. In another embodiment, when the application 103 receives a new message, the MAP 105 may scan the title or subject, and content of the message to determine if there have been any key words or phrases which may be determinative of associated features. In the same way, the MAP 105 may scan the sender's contact name and information, or any additional recipients of the message, for the same purpose. In yet another embodiment, the MAP 105 may seek to identify message content that was sent from a particular contact.

In step 303, the MAP 105 may identify one or more messaging features associated with the contact, the content information, or combination thereof. According to one embodiment, once the MAP 105 has determined the contact and/or content information, the MAP 105 may determine which features the user as associated with the contact and/or content information. For example, whenever the MAP 105 detects the word “contract” in a message, it may be required to handle the message with special treatment, such as an automatic response. In another example, if the MAP 105 detects the word “contract” in the content and that the sender is the user's employer, the feature settings may require the application 103 to send an automatic response and create a pop-up notification on top of all current running applications.

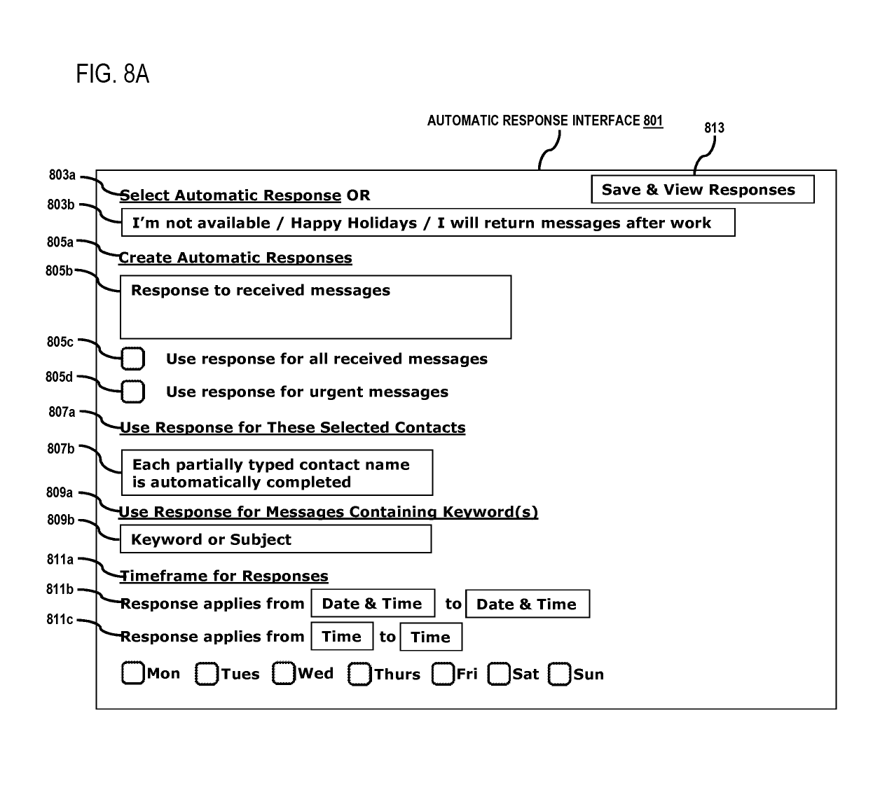

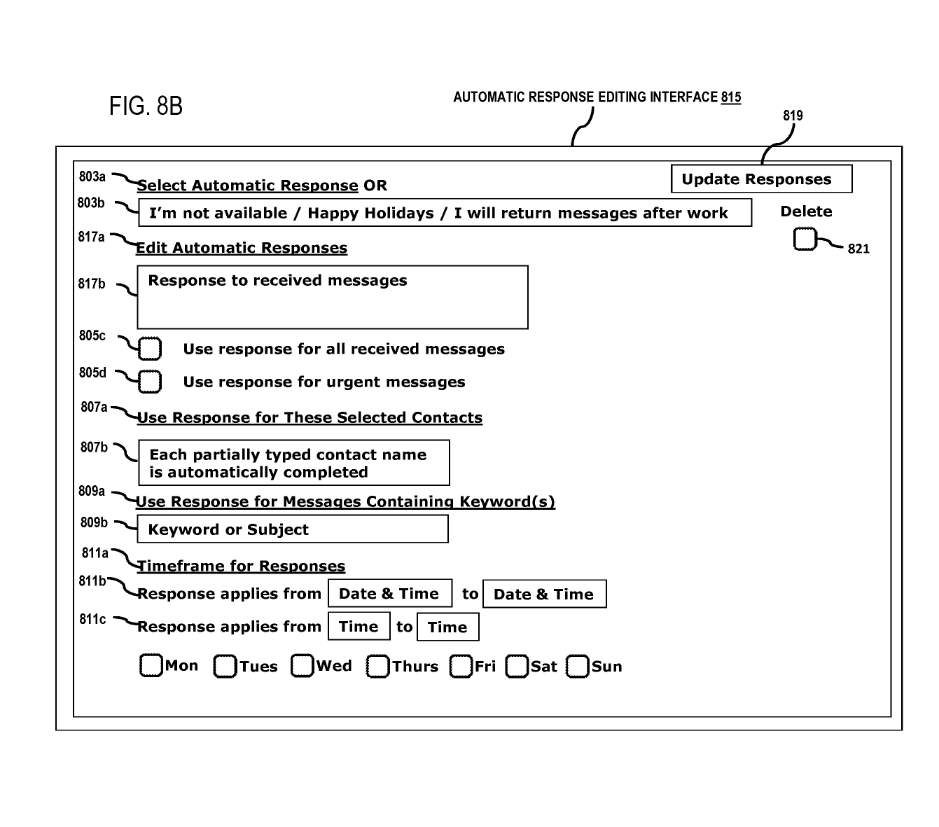

In step, 305, the MAP 105 may configure a messaging application to provide the one or more messaging features when processing the message via the messaging application. The MAP 105 may expose additional user interface menus upon the user's selection of various features to associate with a contact. The additional user interface menus may allow the user to adjust the configurable options associated with a feature for a contact. According to one embodiment, the application 103 may render a user interface displaying a contact name and a list of available features, such as an auto fill dictionary, prompting dictionary, automated responses, etc. According to one embodiment, if the user associates the automated responses by tapping on it, this action may render an expandable sub-menu of additional options related to the automated responses (see FIG. 8A). For example, the additional options may allow a user to select from a number of preset automatic responses, or compose a new automatic response. According to one embodiment, the user may configure the selected automatic response to apply to all messages from a contact, or only to messages containing key words or phrases. According to one embodiment, the user may select a period of time, such as weekdays, or mornings, to enable the automatic response feature.

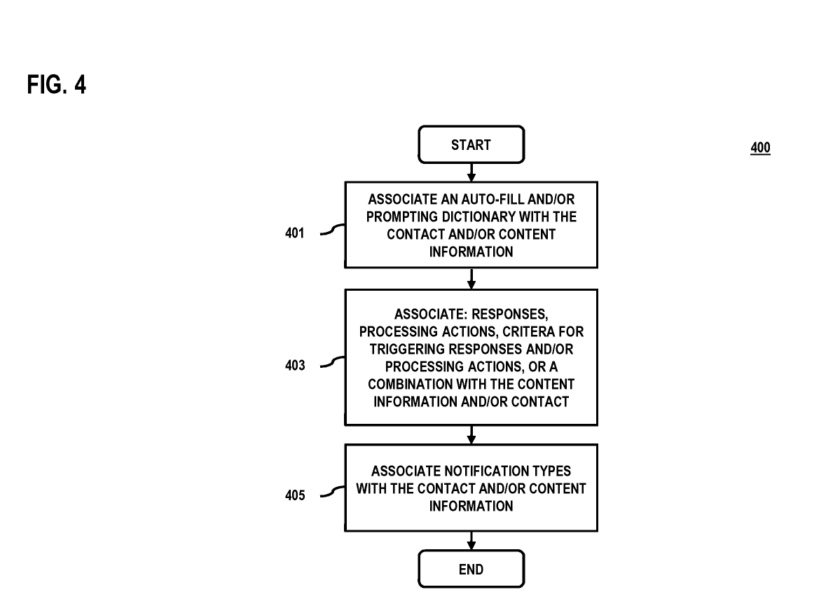

FIG. 4 is a flowchart of executing various messaging features associated with contact and/or content information, according to one embodiment. In one embodiment, the MAP 105 performs the process 400 and is implemented in, for instance, a chip set including a processor and a memory as shown in FIG. 14. Although FIG. 4 illustrates steps 401 through 405 in a particular order, the order and number of steps is merely for explanation, and one or more steps may be performed in a different order or removed. In step 401, the MAP 105 may have one or more messaging application features, wherein the one or more messaging features include an auto-fill feature, a prompting feature, or a combination thereof, the method further comprising: associating an auto-fill dictionary, a prompting dictionary, or a combination with the contact, the content information, or a combination thereof, wherein the auto-fill dictionary, the prompting dictionary, or a combination thereof is unique to the contact, the content information, or a combination thereof. According to one embodiment, the MAP 105 may have learned that messages to Joe usually begin with “Hello Joe”. MAP 105 may add “Hello Joe” to the auto-fill and/or prompting dictionaries for the contact Joe. When the user composes a new message to Joe, the MAP 105 may auto fill this greeting in the message body. In another embodiment, the MAP 105 may have learned that the user's messages to Sue often contain the word “computer”. When the user types a message to Sue and enters the letters “co”, the MAP 105 may prompt the word “computer” by displaying the word and prompting the user to accept or ignore the prompt by pressing enter or closing the word prompt dialogue box, respectively. In another embodiment, the user may select a prompted word by double-tapping the UD 101 screen.

According to one embodiment, if the user deletes or ignores the words that are auto-filled or prompted more than three times (this number may be set by the user), then the MAP 105 may delete the word from the commonly used words dictionary for that contact. According to another embodiment, the MAP 105 may render a pop-up notification asking the user to confirm deletion of a word from the dictionary after the word has been deleted three times. Additionally, if the user ignores the prompted word three times in a row (this threshold may be set by the user), then the application may stop prompting that word. The user may set rules regarding when to delete a commonly used word for a contact. For example, the user's settings may specify that the system 100 remove a commonly used word after three deletions or ignores for Contact A, and five deletions or ignores for Contact B. The user may also disassociate auto fill and prompting features for individual contacts or all contacts.

In step 403, the MAP 105 may have one or more messaging application features, wherein the one or more messaging features include an automatic response feature, the method further comprising: associate (a) one or more responses; (b) one or more processing actions; (c) one or more criteria for triggering the one or more responses, the one or more processing actions, or a combination thereof; or (d) a combination thereof with the contact, the content information, or a combination thereof, wherein (a) the one or more responses; (b) the one or more processing actions; (c) the one or more criteria for triggering the one or more responses, the one or more actions, or a combination thereof; or (d) a combination thereof are unique to the contact, the content information, or a combination thereof. In addition, the MAP 105 may have one or more messaging features, wherein the one or more processing actions include an attachment action, a carbon copying action, an future sending action, a repeat sending action, a message escalation action, a storage action, a message folder creation action, or a combination thereof. According to one embodiment, a user may set a default “Busy” message to all contacts, but associate a specially associated “Out of Town” message to only her sister. In another embodiment, the MAP 105 may include the option to send a copy of text or MMS messages to contacts without letting other contacts know that additional recipients were added.

In another embodiment, custom triggers may be created to invoke specific messaging behaviors. The handling of messages may be defined for all received messages, urgent messages, messages received from certain senders, or messages containing certain content. Criteria may also be selected so that message treatments only apply for a specified duration or during certain times of the day on particular days of the week. For example, a user may set the criteria of forwarding messages from co-workers only during the time the user is away on vacation. Selecting criteria for message responses and processing is similar to creating filtering rules. For example, a user may set up a special outgoing greeting for messages received from a list of friends, or a user may choose to copy all messages from her employer containing the word “project” to select co-workers. In one embodiment, these setting may be stored on the UD 101 or user profile database 117.

In one embodiment, MAP 105 may offer features allowing customization of messages or to establish a theme or style for the user. Additionally, messages may automatically attach media content or text such as uniform resource locators (URLs) to messages. In one embodiment, users may advertise or promote something they are involved with, such as uploaded video content, business, or political campaigns. Criteria may be established to determine situations when the media content or part of the media content may be included. In one embodiment, the content (e.g., videos, URL links, messages, pictures, etc.) to attach may be specific to individual or groups of contacts and/or other message context (e.g., content). For example, acquaintances with common interests such as a sports team, may receive one picture, but a company logo or mission statement might be sent to a supervisor.

In one embodiment, the MAP 105 may support an option for users to send messages at a future time. For example, a user might send a happy birthday message, remind a co-worker about an important meeting, or send a note back to their own UD 101. According to one embodiment, application 103 may integrate these future messages with a built-in calendar, local UD 101 calendar, or web calendars affiliated with email services or social networking groups. For example, each birthday located on a social networking group may be sent a pre-defined birthday message. In another embodiment, pre-defined special messages with content may be sent only to the named person, and for a specific event (e.g., spousal anniversary, son or daughter's birthday, etc.). In another embodiment, a setting may be enabled in the application 103 that may request pre-authorization from the user prior to sending future messages. When pre-authorization is enabled, a report (e.g., in text format) may be sent to the user to authorize all scheduled messages to be sent today, this week, or month. The user may have the capability to authorize all or specific messages only.

In another embodiment, the MAP 105 may support a repeat message sending feature, allowing users the ability to schedule the delivery of messages that are especially related to recurring activities and/or warrants a repetition of messages. The messages may be delivered a finite number of times, until a certain date, until receiving a delivery receipt, or delivered on a regular basis for an infinite duration. The delivery of the messages may be modified or turned off at any time. In another embodiment, the MAP 105 may look for response messages from any or all of the contacts of a sent message as a trigger to stop the repeat message sending. In one embodiment, repeat message sending parameters (e.g., duration between repeat sending, total number repeated messages, etc.) are configurable. In one embodiment, this feature may be modified or turned off midway through the resending schedule. Additionally, the user can also be notified whenever resent messages are initiated.

According to another embodiment, an extension of the repeat messages may be sent if a response is not received. In addition or alternatively, the repeat messages may be sent to other individuals. These additional recipients may not always occupy higher levels of authority (for example, in a professional environment), although they may. The additional contacts may be peers of the initial contact who, for instance, might replace an absentee message recipient. In one embodiment, messages may be escalated to other contacts. For example, escalated messages may be marked with “ESC” so the new recipient may know the message had been escalated to recipient. The trigger for the escalation message may be a configurable timer that the user has to enable before sending the first message. The user may also permanently enable the escalation message feature for specified recipients. In another embodiment, receiving an “out of office” message from an intended recipient can automatically trigger an escalation of the message.

In one embodiment, MAP 105 may store some or all of a user's messages and reports. Messages and reports may be stored on external devices, memory cards, network servers, or cloud servers. As needed, the MAP 105 may support this feature with wired and/or wireless data transfer. For example, MAP 105 may allow for personal storage devices, which some users may prefer for privacy reasons. In one embodiment, the storage options may support message folder and message search features described in sections below via a website interface, mobile client or downloadable computer client.

In one embodiment, the user may have the ability to create folders to store sent and/or received messages. For example, a user may create a folder for each new contact, whether the contact first sends a message to the user, or when a new contact is added to the user's contact book. Thereinafter, all messages to/from this contact may be stored in this folder. However, the messages may not be moved to a given folder unless the user moves the messages manually or creates a message rule to do so. Folders may also be created based on groups or topics such as family, football, book club, or work to categorize messages. Message Folders may be duplicated in each location where user messages are saved. For example, message folders may be saved locally in UD 101, or remotely at the user profile database 117 or MAP 105. Message Folders may be updated on external storage, memory cards or on centralized servers depending up on the user's preference.

In step 405, the MAP 105 may have one or more messaging application features, wherein the one or more messaging features includes a personalized notification feature, the method further comprising: associating one or more notification types with the contact, the content information, or a combination thereof, wherein the one or more notification types are unique to the contact, the content information, or a combination thereof. In addition, the MAP 105 may have one or more messaging features, wherein the one or more notification types include a popup notification, an audio notification, a visual notification, or a combination thereof. According to one embodiment, a user may associate customized notifications for a contact. When the user establishes this association in application 103, the user may set customizable message tones, volume, alerts, and so on according to the contact. Meanwhile, the alert or notification options for the user's application 103 for other contacts may remain unchanged. Thus, a user may have pop-up notifications only for the user's parents and employer, increasing volume tone notifications for the user's friends, and a basic tone notification for the rest of the user's contacts and unknown senders.

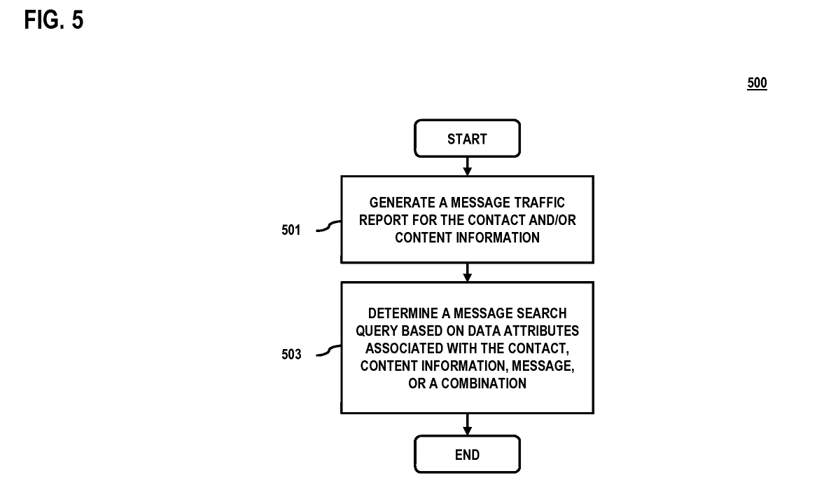

FIG. 5 is a flowchart for providing generated results based on information collected in the messaging application database, according to one embodiment. Although FIG. 5 illustrates steps 501 through 503 in a particular order, the order and number of steps is merely for explanation, and one or more steps may be performed in a different order or removed. In one embodiment, the MAP 105 performs the process 500 and is implemented in, for instance, a chip set including a processor and a memory as shown in FIG. 14. In step 501, the MAP 105 may generate a message traffic report for the contact, the content information, or a combination thereof, either automatically or ad-hoc. According to one embodiment, reports may contain information such as mobile numbers, the number of messages received during a certain interval, dates of sent messages, etc. Reports may be set to generate automatically at regular intervals, such as on a daily, weekly, or monthly basis, or ad-hoc whenever the user so desires. For example, a user may set a weekly report for the number of messages received or a daily report for all messages that have not been replied to. The user may set the report to indicate the number of messages from certain contacts or groups of contacts. For example, the user may set a report indicating the number of messages the user received from co-workers during a particular time interval.

In step 503, the MAP 105 may have one or more messaging features, wherein the one or more message features include a search feature, the method further comprising: determining a message search query based on one or more data attributes associated with the contact, the content information, the message, or a combination thereof. In addition, the MAP 105 may have one or more messaging features, wherein the messaging application is resident on a mobile device client, a network host, a cloud-based host, a web-based client, or a combination thereof. Example search queries may include messages from: “Mom” containing the word “recipe”; delete all messages from “brother” containing the word “loan”; and find all messages from “Jessica” containing the word “movie” in “February 2013”. The user may set the results page to display a predefined number of results, such as 25, 78, or 110.

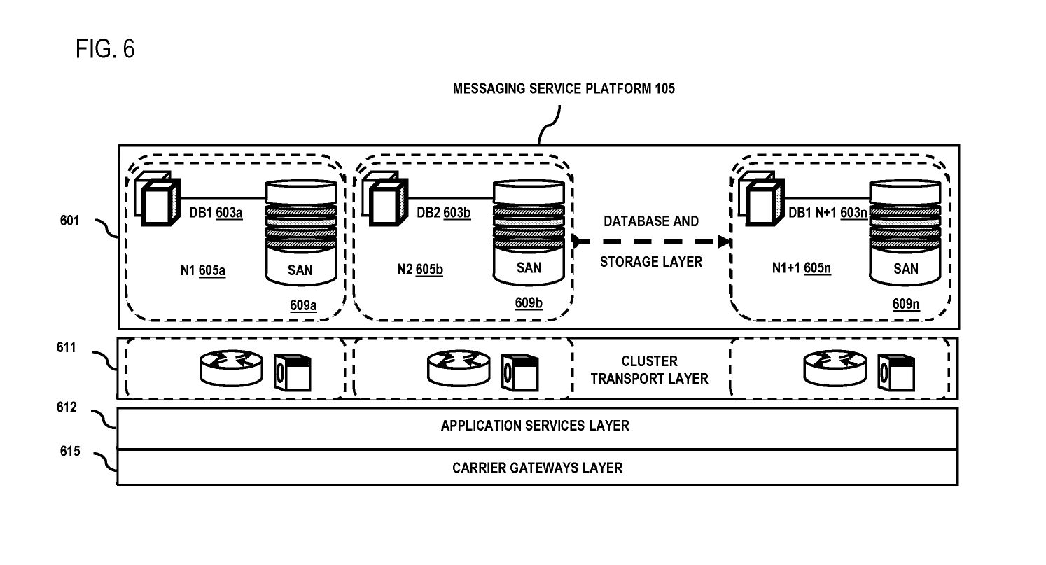

FIG. 6 is a diagram of a messaging application platform used in the processes of FIGS. 3-5, according to one embodiment. In this scenario, the MAP 105 is composed of at least four layers, with each layer providing a different function. The database and storage layer 603 may provide storage for the MAP 105, and may store information such as: user profiles, contacts, associated features, feature settings, commonly used words dictionaries, metadata, etc. The database and storage layer 603 is modular, making expandability an option, which each module consisting of respective databases 603a-603n (DBs 603a-603n), and storage area networks 609a-609n (SANs 609a-609n). The databases 603a-603n store information associated with messaging application 103, while the SANs 609a-609n provide access to the databases 603a-603n by network servers. The cluster transport layer 611 allows for communication between the MAP 105 and the UD 101. The application services layer 612 exposes the various features of the MAP 105 (e.g., via application programming interfaces (APIs). By way of example, the application services layer 612 contains feature engines and services (not shown) that support each respective feature. In one embodiment, the application services layer 612 may be found on the UD 101 or in the MAP 105. However, depending on the capabilities of the UD 101, the application services layer 612 found in the UD 101 may contain fewer feature engines or services. The carrier gateways layer 615 serves as an interfacing layer allowing for communication among the various layers of the MAP 105 and respective providers, carriers, operators, etc. associated with the MAP 105.

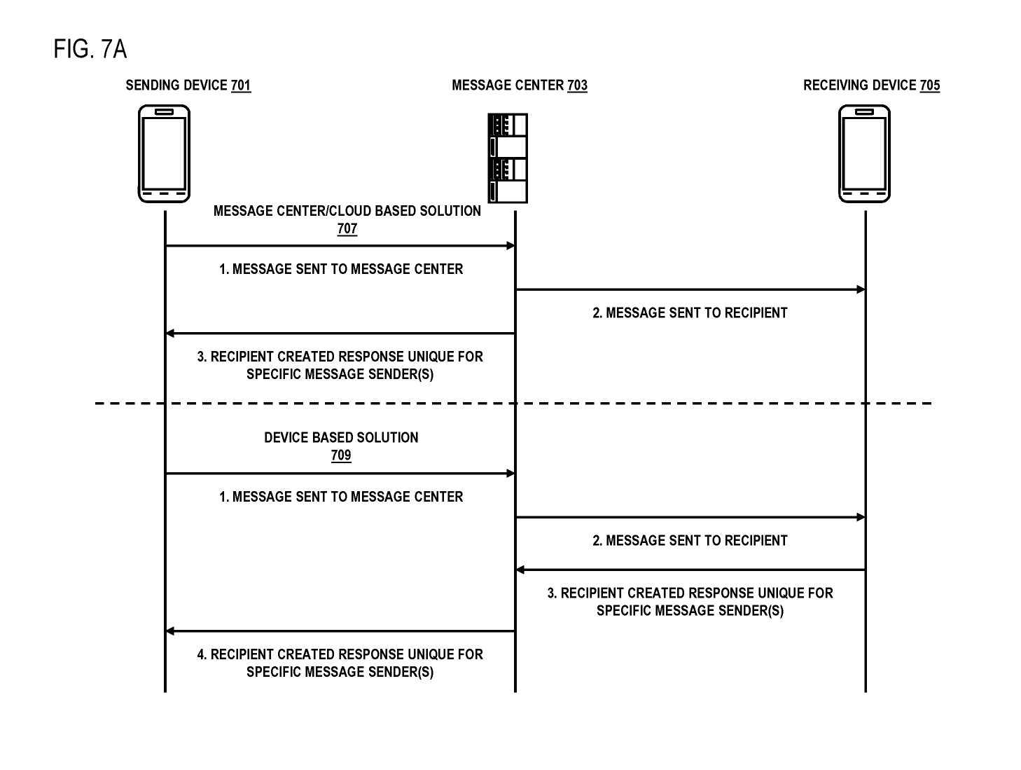

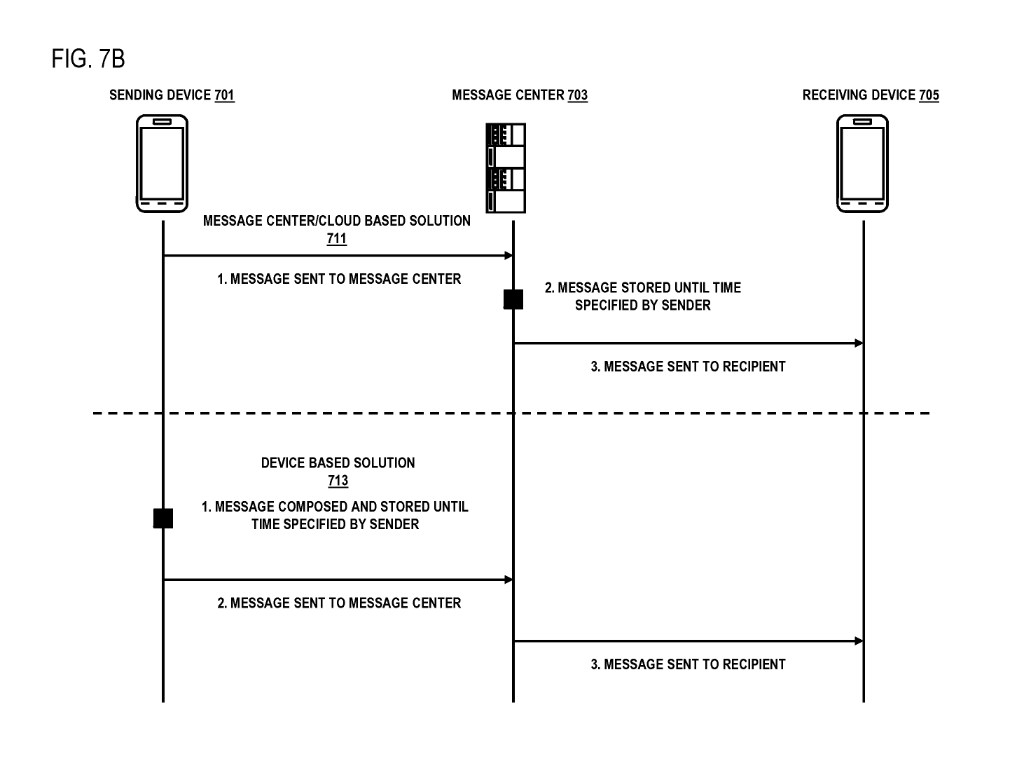

FIGS. 7A and 7B are diagrams of call flows for out of office and future messages, respectively, used in the process of FIG. 4, according to one embodiment. FIG. 7A is a call flow diagram for various out of office messages. The call flow in diagram 7A depicts a scenario where a user has associated an out of office message with one or more contacts, in one embodiment. The message center/cloud based solution 707 illustrates a situation where the subscriber has implemented the system 100 in a network such as the MAP 105. In step 1 of the message center/cloud based solution 707 call flow, the sending device 701 may send a message received by the message center 703. The message center 703 may then perform the following two steps: in step 2, the message center 703 may send the message to the receiving device 705; and in step 3, the message center 703 may send a recipient created response unique for specific message senders to the sending device 701.

The device-based solution 709 illustrates a situation where the subscriber has implemented the system 100 locally in UD 101. In step 1 of the device-based solution 709, the sending device 701 sends a message received by the message center 703. In step 2, the message center 703 sends the message to the recipient's receiving device 705. In step 3, the receiving device 705 may create a response unique for specific message senders. In step 4, the recipient-created response unique for specific senders is received by sending device 701.

FIG. 7B is a call flow diagram for future message sending, according to one embodiment. The message center/cloud based solution 711 illustrates a scenario where a user has composed a message, and set a future sending date for the message. The message center/cloud based solution 711 exemplifies a situation where the subscriber has implemented the system 100 in a network such as the MAP 105. In step 1 of the message center/cloud based solution 711, the sending device 701 may send a message that may be received by the message center 703. In step 2, the message center 703 may store the message until the time specified by the sender. In step 3, the message center 703 may send the message to the receiving device 705 at the date and time specified by the user of sending device 701.

The device based solution 713 illustrates a scenario where a subscriber has implemented system 100 as a device-based application. In step 1 of the device-based solution 713, the user of sending device 701 composes the message. Sending device 701 may store the message locally in the sending device 701 until the time specified by the sender. In step 2, the sending device 701 may send the message to the message center 703 at the time specified by the user. In step 3, the message center 703 may send the message to the receiving device 705.

FIGS. 8A and 8B are diagrams of user interfaces utilized in the process of FIG. 4, according to one embodiment. FIG. 8A illustrates the user interface rendered when the user creates a new automated response. When a user elects to create an automatic response, the application 103 may render the automatic response interface 801. The user may select between saved automatic response messages or compose a new automatic response. The Select Automatic Response 803a option may list the automated responses the user may choose from (803b). According to one embodiment, the list the user may choose from may be preloaded in the application 103. In another embodiment, the list may include former automated responses created by the user for this particular contact, or from all of the automatic responses composed for all of the user's contacts. In another embodiment, the list of automated responses may be a combination of all of the above. The user may be able to select which list of automated responses may be available to her in the application 103's settings.

The Create Automatic Responses 805a may display a text area (805b) where the user may draft a new automatic response. The user may opt to use the response for all received messages by checking the first box (805c), or the user may use the response for messages marked as urgent, in which the user may check the second box (805d). The user may then select which contacts to associate with this automated response (807a). When the user begins to type a contact's name in the field (807b), the application 103 may complete entry of the contact's name. All of the names listed in the 807b field may be recipients of the automated response. The user may also prompt an automated response with content information (809a). In order to do so, the user may type the content items that the user would like to trigger an automated response in the text field (809b). The user may set time frames for the automated responses to be active (811a). To do so, the user may enter a set of to and from dates (811b) and/or the user may select to and from times and check which days of the week the automated responses should apply (811c). When the user selects the save and view responses button 813, the system 100 may save the settings and will render a list of the automatic response message with its associated configured details.

FIG. 8B illustrates the user interface rendered by the system 100 when the user edits an automated user response. When the user elects to edit or delete an automated response, the system 100 may render an automated response editing interface 815. The automated response editing interface 815 is similar to the automatic response interface 801 in every way, but with a few exceptions. The create automatic response 805a section may be replaced with an edit automatic response (817a) section, wherein instead of a create new automatic response text area 805b, the user may edit a current response, which may populate automatically in the field (817b). The user may configure all of the other options available in the automatic response interface 801 screen, such as: select an automated response (803), use the response for all received messages (805c), use response for urgent messages (805d), use response for selected contacts (807), and set the time frame for responses (811). The user may update the response (819) to save all changes. The user may delete an automatic response by checking the delete checkbox (821), and then select the update response (819) to delete the current automated message.

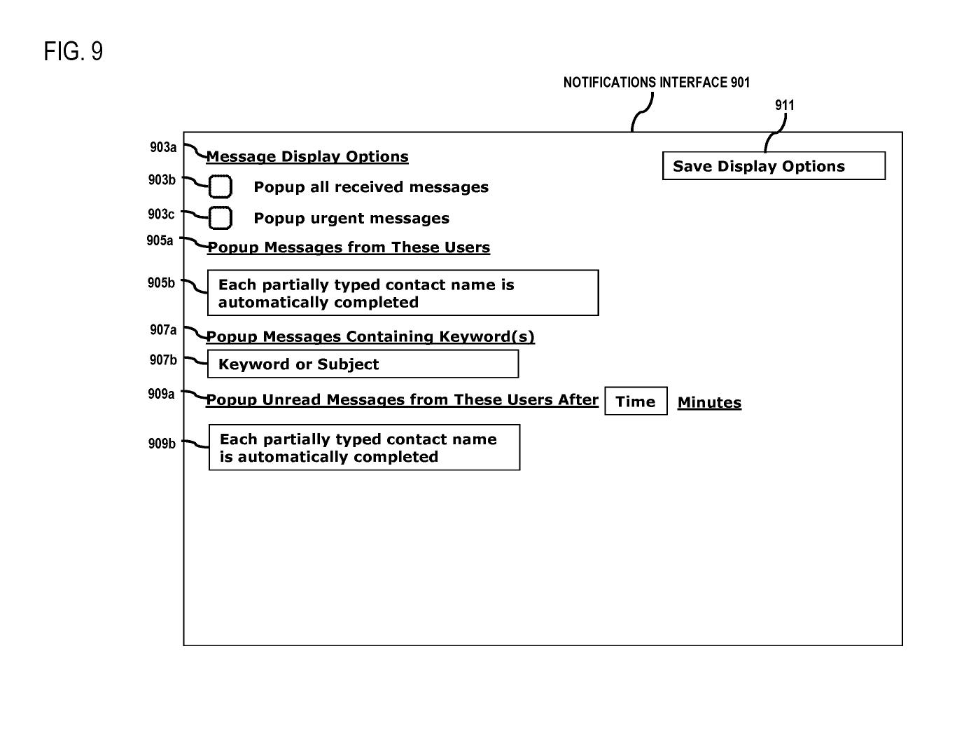

FIG. 9 is a diagram of a user interface utilized in the process of FIG. 4, according to one embodiment. When the user associates notifications for a contact, the system 100 may render the notifications interface 901. The user may select the message display options (903a), and may choose from pop up notifications for all received messages (903b) or only for messages marked as urgent (903c). The notifications interface 901 allows the user to enter the contacts from whom she wants to receive pop-up notifications (905a). The user may select the associated contacts by entering the contact's name in the corresponding field (905b). When the user begins to type a contact's name in the field (905b), the application 103 may complete entry of the contact's name. All of the names listed in the 905b field may trigger a pop-up notification for the UD 101. The user may also trigger a pop up notification with content information (907a) by typing the content items that should trigger a pop up notification in the text field (907b). The user may select a second tier of contacts (909) from whom to receive notification alerts in case the first tier (905) of pop up alert contacts' messages goes unread. The user may activate this feature by entering the amount of time in the text entry field (909a) that a pop-up notification may go unread before activating the second tier of contacts to initiate a pop-up notification (909b). According to one embodiment, the system 100 may not allow the same names in both the first tier of pop-up notification contacts (905b) and the second tier of pop-up notification contacts (909b) fields. The user may select the Save Display Options 911 to save the current notifications configuration.

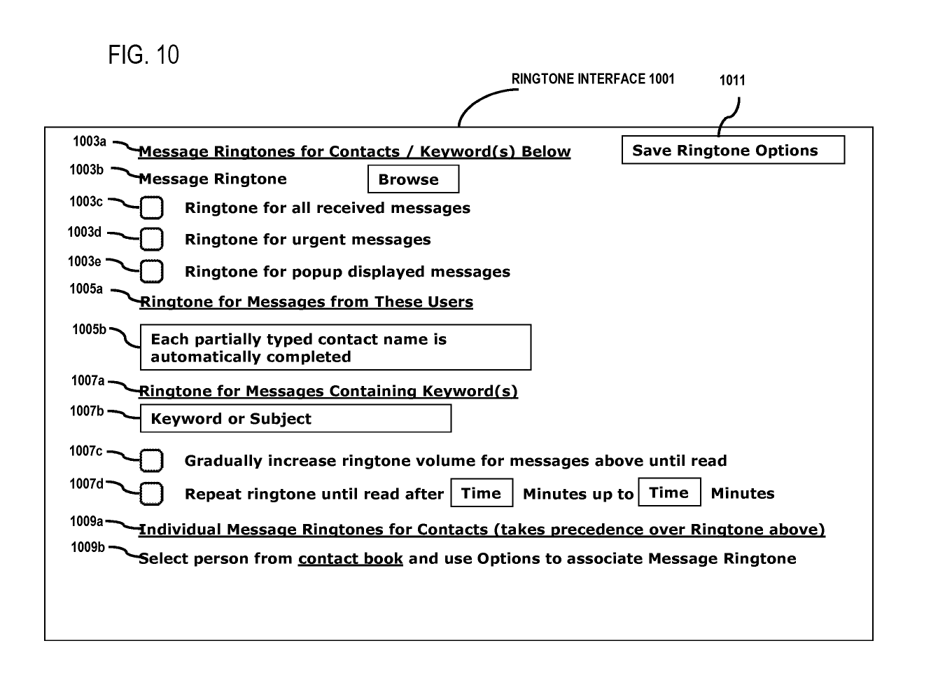

FIG. 10 is a diagram of a user interface utilized in the process of FIG. 4, according to one embodiment. When the user associates customized ringtones for a contact, the system 100 may render the ringtones interface 1001. The interface may contain system-wide ringtone options (1003a) which may allow a user to select a default ringtone (1003b). Once the user selects the default ringtone (1003b), the user may select whether the ringtone applies to: all received messages (1003c), only messages marked urgent (1003d), or messages that may appear as a pop up display (1003e). The user may associate the selected ringtone (1003b) to a contact (1005a) by entering the contact name in field 1005b. When the user begins to type a contact's name in the field 1005b, the application 103 may complete entry of the contact's name. All of the names listed in the field 1005b may be associated with the selected ringtone (1003b). The user may also associate a ringtone according to content information (1007a) by typing the content items that the user would like to associate with the ringtone (1003b) in the text field 1007b. The user may configure additional settings for the selected ringtone (1003b), such as gradually increase the ringtone volume for associated messages until read (1007c), or repeat the ringtone until read after a certain amount of time, or up to a certain amount of time (1007d). If the user associates the ringtone with a single contact (1009a), the user may click on the contact book link and select the contact to associate (1009b). The user may save her settings by clicking the Save Ringtone Options button 1011.

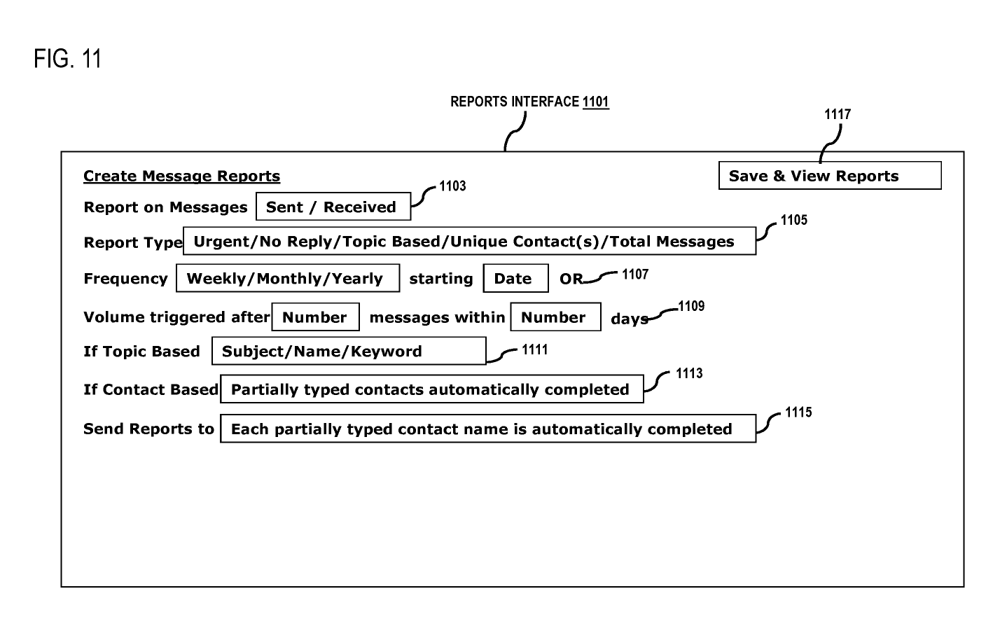

FIG. 11 is a diagram of a user interface utilized in the process of FIG. 5, according to one embodiment. When the user generates a report, the system 100 may render the reports interface 1101. The user may select options such as whether the system 100 may create a report of messages sent or received (1103). The user may also have the report consider the message status (1105). For example, a message status may encompass whether: the message has been marked as urgent, the user has replied to the message, message topic, contacts, or all messages. The user may set the frequency of the reports (1107). For example, the user may set the reports to generate weekly, monthly, or yearly. The user may set a starting date for the recurring reports. Additionally, the user may set a report trigger upon collecting a pre-set number of relevant messages (1109). The user may enter the number desired (e.g., generate report upon receiving 100 relevant messages) within a window of time (e.g., 5 days). The user may also create the report based on a specific topic (1111) by entering the topic into the text field. The user may set the report based on messages from a certain contact (1113) by entering the contact name into the text field. When the user begins to type a contact's name in the field (1113), the application 103 may complete entry of the contact's name. The user may send the report to contacts (1115). The user may save and view the configured reports by selecting the Save & View Reports button 1117.

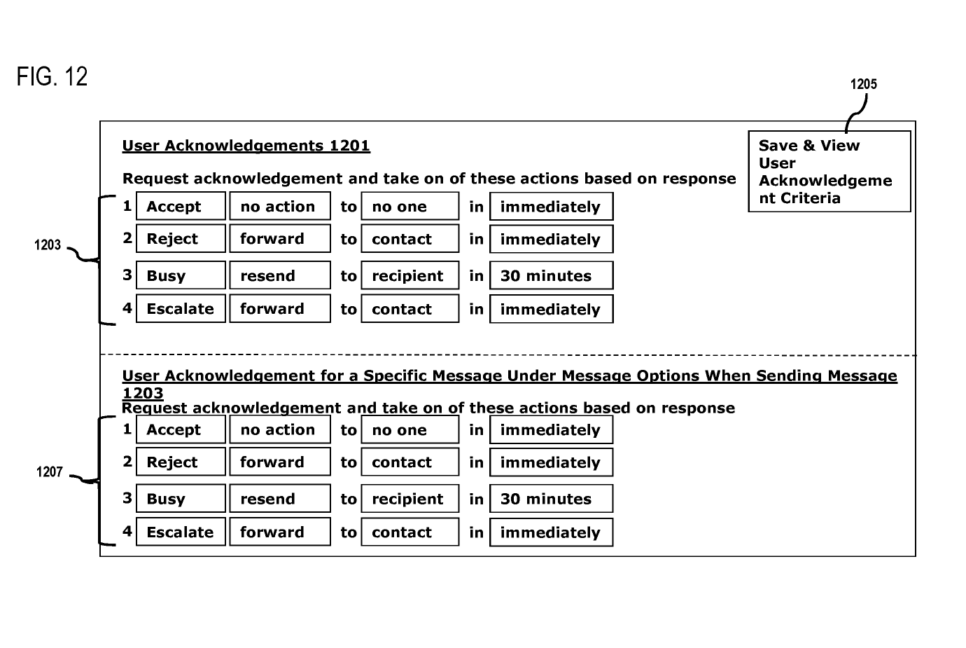

FIG. 12 is a diagram of a user interface utilized in the process of FIG. 4, according to one embodiment. User acknowledgements may be set by users or machines to perform additional actions, such as escalating or preventing the receipt of repeat messages. Once established, the system 100 executes the associated responses, so that users do not have to take repetitious action. For example, when the user associates user acknowledgements, the system 100 may render the user interfaces in user acknowledgments 1201. In user acknowledgements 1201, the user may create a number of settings which may inform the system 100 regarding the handling of various received messages. The user may manipulate these settings by entering commands, processes, contacts, and time into the appropriate various fields in section 1203. According to one embodiment, each selection of the selection field may consist of a drop down menu form which the user may select her choice. For example, a use may set the user acknowledgment to simply accept a new message by selecting “Accept” in the first (or command) field and then “immediately” in the time field. Alternatively, the user may choose to reject an incoming message by selecting “Reject”, select “forward” from the processes drop down, select a contact from the destination drop down, and “immediately” in the time drop down. Additional action items include “Busy” and “Escalate,” while additional processes may include “resend’ and “forward.” In user acknowledgements for a specific message under message options when sending message 1203, the user may request special acknowledgements for the messages the user is sending out, as opposed to the messages the user is receiving, such as in the user acknowledgements 1201 user interface. The user may select from the same set of command, process, contacts, and time fields 1207 in the user acknowledgement 1201 section. According to one embodiment, the user may save her selection by pressing the Save & View User Acknowledgement Criteria button 1205.

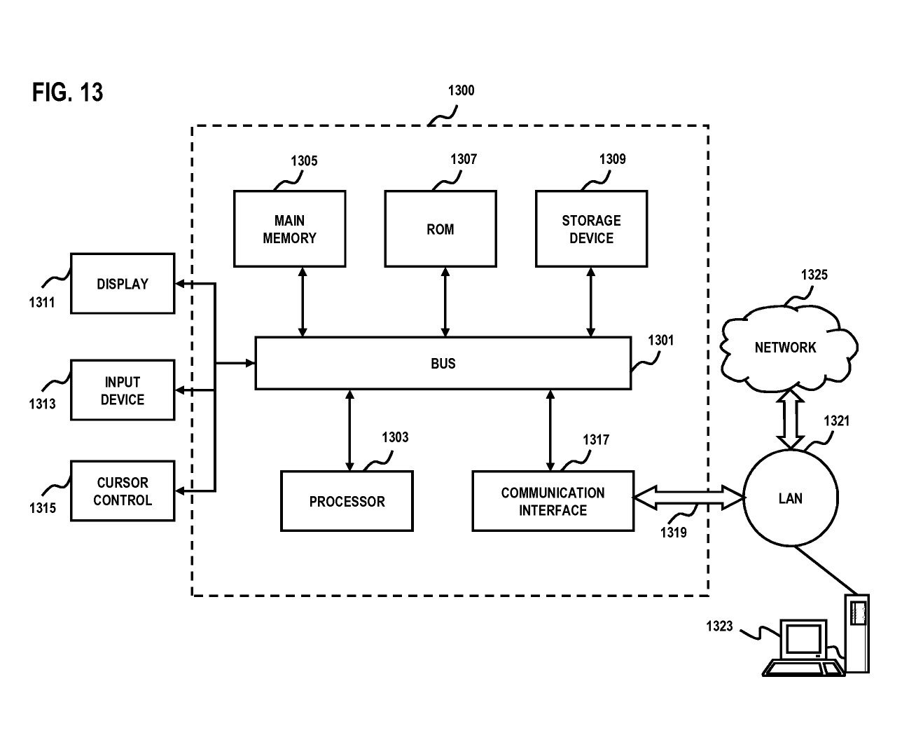

FIG. 13 illustrates computing hardware (e.g., computer system) upon which an embodiment according to the invention can be implemented. The computer system 1300 includes a bus 1301 or other communication mechanism for communicating information and a processor 1303 coupled to the bus 1301 for processing information. The computer system 1300 also includes main memory 1305, such as random access memory (RAM) or other dynamic storage device, coupled to the bus 1301 for storing information and instructions to be executed by the processor 1303. Main memory 1305 also can be used for storing temporary variables or other intermediate information during execution of instructions by the processor 1303. The computer system 1300 may further include a read only memory (ROM) 1307 or other static storage device coupled to the bus 1301 for storing static information and instructions for the processor 1303. A storage device 1309, such as a magnetic disk or optical disk, is coupled to the bus 1301 for persistently storing information and instructions.

The computer system 1300 may be coupled via the bus 1301 to a display 1311, such as a cathode ray tube (CRT), liquid crystal display, active matrix display, or plasma display, for displaying information to a computer user. An input device 1313, such as a keyboard including alphanumeric and other keys, is coupled to the bus 1301 for communicating information and command selections to the processor 1303. Another type of user input device is a cursor control 1315, such as a mouse, a trackball, or cursor direction keys, for communicating direction information and command selections to the processor 1303 and for controlling cursor movement on the display 1311.

According to an embodiment of the invention, the processes described herein are performed by the computer system 1300, in response to the processor 1303 executing an arrangement of instructions contained in main memory 1305. Such instructions can be read into main memory 1305 from another computer-readable medium, such as the storage device 1309. Execution of the arrangement of instructions contained in main memory 1305 causes the processor 1303 to perform the process steps described herein. One or more processors in a multi-processing arrangement may also be employed to execute the instructions contained in main memory 1305. In alternative embodiments, hard-wired circuitry may be used in place of or in combination with software instructions to implement the embodiment of the invention. Thus, embodiments of the invention are not limited to any specific combination of hardware circuitry and software.

The computer system 1300 also includes a communication interface 1317 coupled to bus 1301. The communication interface 1317 provides a two-way data communication coupling to a network link 1319 connected to a local network 1321. For example, the communication interface 1317 may be a digital subscriber line (DSL) card or modem, an integrated services digital network (ISDN) card, a cable modem, a telephone modem, or any other communication interface to provide a data communication connection to a corresponding type of communication line. As another example, communication interface 1317 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1317 sends and receives electrical, electromagnetic, or optical signals that carry digital data streams representing various types of information. Further, the communication interface 1317 can include peripheral interface devices, such as a Universal Serial Bus (USB) interface, a PCMCIA (Personal Computer Memory Card International Association) interface, etc. Although a single communication interface 1317 is depicted in FIG. 13, multiple communication interfaces can also be employed.

The network link 1319 typically provides data communication through one or more networks to other data devices. For example, the network link 1319 may provide a connection through local network 1321 to a host computer 1323, which has connectivity to a network 1325 (e.g. a wide area network (WAN) or the global packet data communication network now commonly referred to as the “Internet”) or to data equipment operated by a service provider. The local network 1321 and the network 1325 both use electrical, electromagnetic, or optical signals to convey information and instructions. The signals through the various networks and the signals on the network link 1319 and through the communication interface 1317, which communicate digital data with the computer system 1300, are exemplary forms of carrier waves bearing the information and instructions.

The computer system 1300 can send messages and receive data, including program code, through the network(s), the network link 1319, and the communication interface 1317. In the Internet example, a server (not shown) might transmit requested code belonging to an application program for implementing an embodiment of the invention through the network 1325, the local network 1321 and the communication interface 1317. The processor 1303 may execute the transmitted code while being received and/or store the code in the storage device 1309, or other non-volatile storage for later execution. In this manner, the computer system 1300 may obtain application code in the form of a carrier wave.

The term “computer-readable medium” as used herein refers to any medium that participates in providing instructions to the processor 1303 for execution. Such a medium may take many forms, including but not limited to non-volatile media, volatile media, and transmission media. Non-volatile media include, for example, optical or magnetic disks, such as the storage device 1309. Volatile media include dynamic memory, such as main memory 1305. Transmission media include coaxial cables, copper wire and fiber optics, including the wires that comprise the bus 1301. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 14 illustrates a chip set 1400 upon which an embodiment of the invention may be implemented. Chip set 1400 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1400, or a portion thereof, constitutes a means for performing one or more steps of FIGS. 2-4, 7, and 9A-9D.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1405 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
determining a contact, content information, or combination thereof associated with a message;
identifying one or more messaging features associated with the contact, the content information, or combination thereof; and
configuring a messaging application to provide the one or more messaging features when processing the message via the messaging application.

2. A method of claim 1, wherein the one or more messaging features include an auto-fill feature, a prompting feature, or a combination thereof, the method further comprising:
associating an auto-fill dictionary, a prompting dictionary, or a combination with the contact, the content information, or a combination thereof,
wherein the auto-fill dictionary, the prompting dictionary, or a combination thereof is unique to the contact, the content information, or a combination thereof.

3. A method of claim 1, wherein the one or more messaging features include an automatic response feature, the method further comprising:
associating (a) one or more responses; (b) one or more processing actions; (c) one or more criteria for triggering the one or more responses, the one or more processing actions, or a combination thereof; or (d) a combination thereof with the contact, the content information, or a combination thereof,
wherein (a) the one or more responses; (b) the one or more processing actions; (c) the one or more criteria for triggering the one or more responses, the one or more actions, or a combination thereof; or (d) a combination thereof are unique to the contact, the content information, or a combination thereof.

4. A method of claim 3, wherein the one or more processing actions include an attachment action, a carbon copying action, a future sending action, a repeat sending action, a message escalation action, a storage action, a message folder creation action, or a combination thereof.

5. A method of claim 1, wherein the one or more messaging features include a personalized notification feature, the method further comprising:
associating one or more notification types with the contact, the content information, or a combination thereof,
wherein the one or more notification types are unique to the contact, the content information, or a combination thereof.

6. A method of claim 5, wherein the one or more notification types include a popup notification, an audio notification, a visual notification, or a combination thereof.

7. A method of claim 1, further comprising:
generating a message traffic report for the contact, the content information, or a combination thereof.

8. A method of claim 1, wherein the one or more message features include a search feature, the method further comprising:
determining a message search query based on one or more data attributes associated with the contact, the content information, the message, or a combination thereof.

9. A method of claim 1, wherein the messaging application is resident on a mobile device client, a network host, a cloud-based host, a web-based client, or a combination thereof.

10. An apparatus comprising a processor configured to:
determine a contact, content information, or combination thereof associated with a message;
identify one or more messaging features associated with the contact, the content information, or combination thereof; and
configure a messaging application to provide the one or more messaging features when processing the message via the messaging application.

11. An apparatus of claim 10, wherein the one or more messaging features include an auto-fill feature, a prompting feature, or a combination thereof, and wherein the processor is further configured to:
associate an auto-fill dictionary, a prompting dictionary, or a combination with the contact, the content information, or a combination thereof,
wherein the auto-fill dictionary, the prompting dictionary, or a combination thereof is unique to the contact, the content information, or a combination thereof.

12. An apparatus of claim 10, wherein the one or more messaging features include an automatic response feature, and wherein the processor is further configured to:
associate (a) one or more responses; (b) one or more processing actions; (c) one or more criteria for triggering the one or more responses, the one or more processing actions, or a combination thereof; or (d) a combination thereof with the contact, the content information, or a combination thereof,
wherein (a) the one or more responses; (b) the one or more processing actions; (c) the one or more criteria for triggering the one or more responses, the one or more actions, or a combination thereof; or (d) a combination thereof are unique to the contact, the content information, or a combination thereof.

13. An apparatus of claim 12, wherein the one or more processing actions include an attachment action, a carbon copying action, a future sending action, a repeat sending action, a message escalation action, a storage action, a message folder creation action, or a combination thereof.

14. An apparatus method of claim 10, wherein the one or more messaging features include a personalized notification feature, and wherein the processor is further configured to:
associate one or more notification types with the contact, the content information, or a combination thereof,
wherein the one or more notification types are unique to the contact, the content information, or a combination thereof.

15. An apparatus of claim 14, wherein the one or more notification types include a popup notification, an audio notification, a visual notification, or a combination thereof.

16. An apparatus of claim 10, wherein the processor is further configured to:
generate a message traffic report for the contact, the content information, or a combination thereof.

17. An apparatus of claim 10, wherein the one or more message features include a search feature, and wherein the processor is further configured to:
determine a message search query based on one or more data attributes associated with the contact, the content information, the message, or a combination thereof.

18. An apparatus of claim 10, wherein the messaging application is resident on a mobile device client, a network host, a cloud-based host, a web-based client, or a combination thereof.

19. A system comprising:
a messaging support platform configured to determine a contact, content information, or combination thereof associated with a message, identify one or more messaging features associated with the contact, the content information, or combination thereof; and
configure a messaging application to provide the one or more messaging features when processing the message via the messaging application.

20. A system of claim 19, wherein the one or more messaging features include an auto-fill feature, a prompting feature, or a combination thereof, and wherein the messaging support platform is further configured to:
associate an auto-fill dictionary, a prompting dictionary, or a combination with the contact, the content information, or a combination thereof,
wherein the auto-fill dictionary, the prompting dictionary, or a combination thereof is unique to the contact, the content information, or a combination thereof.
